(19) United States
(12) Patent Application Publication
(10) Pub. No.: US 2026/0231083 A1
(43) Pub. Date: Aug. 6, 2026

(54) METHODS AND APPARATUSES FOR SIDELINK POSITIONING

(71) Applicant: Lenovo (Beijing) Limited, Beijing (CN)

(72) Inventors: Jing Han, Beijing (CN); Jie Hu, Beijing (CN); Lihua Yang, Beijing (CN); Luning Liu, Beijing (CN); Haiming Wang, Beijing (CN)

(73) Assignee: Lenovo (Beijing) Limited, Beijing (CN)

(21) Appl. No.: 19/148,190

(22) PCT Filed: Jan. 19, 2023
(86) PCT No.: PCT/CN2023/073066

§ 371 Date: Jul. 15, 2025

(51) Int. Cl. H04W 64/00; H04L 1/18; H04W 92/18

(52) U.S. Cl. CPC H04W 64/00; H04L 1/18; H04W 92/18

(57) ABSTRACT

Embodiments of the present disclosure relate to methods and apparatuses for sidelink (SL) positioning. According to an embodiment of the present disclosure, a first user equipment (UE) can include: a transceiver; and a processor coupled to the transceiver and configured to: establish an SL positioning protocol (SLPP) session with multiple second UEs; and groupcast, with the transceiver, an SLPP message in the SLPP session to the multiple second UEs.

### TECHNICAL FIELD

Embodiments of the present application generally relate to wireless communication technologies, and especially to methods and apparatuses for sidelink (SL) positioning.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

SL positioning refers to transmitting positioning reference signal (PRS) over SL, which can operate independently of network or radio access technology (RAT) coverage and provide a new positioning method that fits new network use cases. Currently, details regarding group SL positioning need to be further discussed.

### SUMMARY OF THE APPLICATION

Embodiments of the present application at least provide technical solutions for SL positioning.

According to some embodiments of the present application, a first UE may include: a transceiver; and a processor coupled to the transceiver and configured to: establish an SL positioning protocol (SLPP) session with multiple second UEs; and groupcast, with the transceiver, an SLPP message in the SLPP session to the multiple second UEs.

In some embodiments of the present application, the SLPP message includes an indicator indicating that acknowledgement for the SLPP message is requested and a sequence number of the SLPP message.

In some embodiments of the present application, the processor is further configured to: in response to receiving an SLPP acknowledgement including the sequence number of the SLPP message from each of one or more second UEs of the multiple second UEs, groupcast, with the transceiver, a next SLPP message in the SLPP session to the multiple second UEs, wherein the one or more second UE includes all the multiple second UEs or all second UEs in the multiple second UEs which are within a minimum communication range of a groupcast service.

In some embodiments of the present application, the processor is further configured to perform: step (1): determining whether no SLPP acknowledgement including the sequence number of the SLPP message has been received from at least one second UE of the one or more second UEs before a time period has elapsed since a last transmission of the SLPP message; and step (2): in response to determining that no SLPP acknowledgement including the sequence number of the SLPP message has been received from at least one second UE of the one or more second UEs before the time period has elapsed since the last transmission of the SLPP message, re-transmit, with the transceiver, the SLPP message to the multiple second UEs.

In some embodiments of the present application, the processor is further configured to: repeatedly perform the step (1) and the step (2) until an SLPP acknowledgement including the sequence number of the SLPP message is received from each of the one or more second UEs or a maximum number of re-transmissions of the SLPP message is reached.

In some embodiments of the present application, in response to that the maximum number of re-transmissions of the SLPP message is reached, the processor is further configured to: abort the SLPP session and groupcast, with the transceiver, an indication indicating that the SLPP session is aborted to the multiple second UEs; abandon a second UE in the one or more second UEs from which no SLPP acknowledgement including the sequence number of the SLPP message has been received; re-transmit the SLPP message to the second UE, from which no SLPP acknowledgement including the sequence number of the SLPP message has been received, via an existing unicast connection; or trigger to establish a unicast connection with the second UE, from which no SLPP acknowledgement including the sequence number of the SLPP message has been received, for re-transmitting the SLPP message to the second UE.

In some embodiments of the present application, the processor is further configured to: receive, with the transceiver, an indication indicating an error for the SLPP message from a second UE of the multiple second UEs; and in response to receiving the indication: abort the SLPP session and groupcast, with the transceiver, an indication indicating that the SLPP session is aborted to the multiple second UEs; determine that an SLPP transaction associated with the SLPP message is failed and groupcast, with the transceiver, an identity (ID) of the failed SLPP transaction to the multiple second UEs; or abandon the second UE and continue the SLPP session for other second UEs of the multiple second UEs.

In some embodiments of the present application, the processor is further configured to determine that a cast type used for the SLPP message is groupcast based on at least one of: a type of the SLPP message; a group layer-2 ID for a positioning group associated with the SLPP session being maintained by the first UE; a broadcast layer-2 ID associated with a location service which is associated with the SLPP session being maintained by the first UE; a number of second UEs to which the SLPP message is to be transmitted being larger than 1; no unicast connection existing between the first UE and second UE(s) to which the SLPP message is to be transmitted; or a type of the first UE.

According to some embodiments of the present application, a second UE may include: a transceiver; and a processor coupled to the transceiver and configured to: establish an SLPP session with a first UE and one or more other second UEs; and receive, with the transceiver, an SLPP message in the SLPP session groupcast from the first UE.

In some embodiments of the present application, the SLPP message includes an indicator indicating that acknowledgement for the SLPP message is requested and a sequence number of the SLPP message.

In some embodiments of the present application, the processor is further configured to transmit, with the transceiver, an SLPP acknowledgement including the sequence number of the SLPP message in response to receiving the SLPP message and successfully decoding the indicator and the sequence number.

In some embodiments of the present application, in the case that the second UE fails to decode at least one of the indicator or the sequence number, the processor is further configured to: receive the SLPP message re-transmitted from the first UE via an existing unicast connection; or establish a unicast connection with the first UE, and receive the SLPP message re-transmitted from the first UE via the unicast connection.

In some embodiments of the present application, the processor is further configured to: in response to detecting an error for the SLPP message, transmit, with the transceiver, an indication indicating an error for the SLPP message to the first UE.

In some embodiments of the present application, the processor is further configured to: in response to receiving an indication indicating that the SLPP session is aborted groupcast from the first UE, discard stored SLPP message(s) for the SLPP session and stop an ongoing SLPP transaction of the SLPP session; or in response to receiving an ID of a failed SLPP transaction groupcast from the first UE, discard stored SLPP message(s) for the failed SLPP transaction.

According to some embodiments of the present application, a method performed by a first UE may include: establishing an SLPP session with multiple second UEs; and groupcasting an SLPP message in the SLPP session to the multiple second UEs.

According to some embodiments of the present application, a method performed by a second UE may include: establishing an SLPP session with a first UE and one or more other second UEs; and receiving an SLPP message in the SLPP session groupcast from the first UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary SLPP acknowledgement procedure according to some embodiments of the present application;

FIG. 3 illustrates an exemplary SLPP retransmission procedure according to some embodiments of the present application;

FIG. 4 illustrates an exemplary SLPP error handling procedure according to some embodiments of the present application; and

FIG. 5 illustrates a simplified block diagram of an exemplary apparatus for SL positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE, LTE-advanced, 5G (i.e., new radio (NR)), 5G-advanced, 6G, and so on. Persons skilled in the art know very well that, with the development of network architecture and new service scenarios, the embodiments in the present application are also applicable to similar technical problems; and moreover, the terminologies recited in the present application may change, which should not affect the principle of the present application.

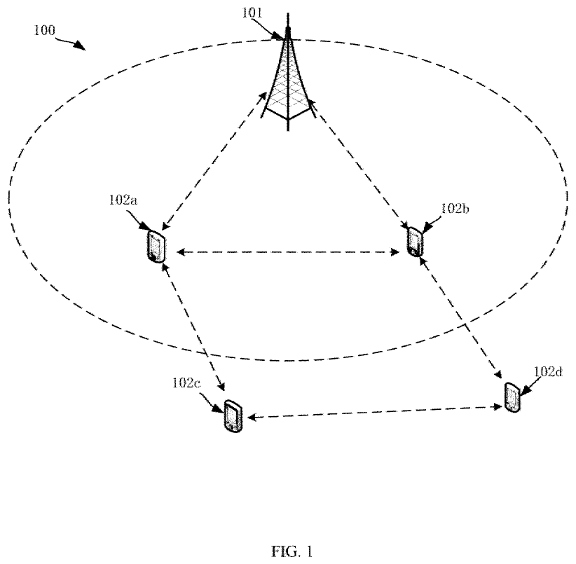

FIG. 1 is a schematic diagram illustrating an exemplary wireless communication system 100 according to some embodiments of the present application.

As shown in FIG. 1, the wireless communication system 100 includes at least one BS 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced or evolved node B (eNB), a generalized node B (gNB), a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs), road side unit (RSU), vulnerable road users (VRUs), public safety UEs (PS-UEs), and/or commercial sidelink UEs (CS-UEs). In an embodiment of the present application, a VRU may include a pedestrian UE (P-UE), a cyclist UE, a wheelchair UE or other UEs.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the example shown in FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

With respect to the sidelink positioning procedures between UEs, SLPP is introduced to support at least the following functionalities: SL positioning capability transfer, SL positioning assistance data exchange, SL location information transfer, error handling, abort, etc.

The cast type for SLPP signaling may include unicast, groupcast and broadcast. Unicast/one-to-one operation may be assumed as baseline for exchange of SLPP signaling between UEs. Unicast SLPP session-based operation and “centralized” operation are both supported for SL positioning. For example, the “centralized” operation may refer to an operation where one UE performs range and/or position calculations based on measurement/location information relating to itself and/or other UEs.

For SLPP, a use case with one target UE and one or more anchor UEs may exist. A target UE may be a UE whose position (or location) needs to be calculated or known. An anchor UE may be a UE which participates in SL positioning and helps the target UE to acquire its position, e.g., by sending/receiving SL-PRS and doing relevant measurements. In addition, a use case with multiple target UEs may also exist. For a use case with multiple target UEs, both session-based and session-less SLPP procedures are possible. In a session-based SLPP procedure, one or more target UEs and one or more anchor UEs are in the same SLPP session (or in the same group). There may be one location request and SLPP messages in the SLPP session are associated with the location request, and multiple target UEs in the SLPP session may calculate their positions. Both use cases (i.e., a use case with one target UE and a use case with multiple target UEs) may support session-based SLPP message transport. In addition, both use cases may include a one-to-many operation, i.e., an SLPP message is transmitted by one UE and received by multiple UEs. Similar to legacy LPP procedure, SLPP message reliable transport can be supported for session-based SLPP message transport. However, how to support SLPP message reliable transport for one-to-many use cases in group SL positioning is not discussed yet.

Specifically, SLPP message reliable transport for one-to-many use cases in group SL positioning may involve the following issues.

Issue #1: how to support SLPP message reliable transport when there are multiple receiving UEs which receive SLPP message(s).

For example, a legacy LTE positioning protocol (LPP) procedure may support LPP message reliable transport by LPP acknowledgement. That is, after transmitting an LPP message, a transmitter (or a transmitting UE) may not transmit the next LPP message but wait for LPP acknowledgement (ACK) from a peer endpoint (e.g., a receiver or a receiving UE which receives the LPP message). After the transmitter receives an LPP ACK for the LPP message from the peer endpoint, the transmitter may transmit the next LPP message. However, for SLPP, if SLPP ACK is supported, there may be multiple endpoints which may feedback ACKs. Then, how to handle the multiple ACKs by the transmitter needs to be discussed.

As another example, a legacy LPP procedure may also support LPP message reliable transport by LPP message retransmission. That is, after transmitting an LPP message, if a transmitter (or a transmitting UE) cannot receive LPP ACK for the LPP message from a peer endpoint (e.g., a receiver or a receiving UE which receives the LPP message) during a time period, the transmitter may retransmit the LPP message. The transmitter may repeat such action until a maximum retransmission number is reached, or LPP ACK for the LPP message is received from the peer endpoint by the transmitter. However, for SLPP, as described above, there may be multiple endpoints which may feedback ACKs, and thus multiple possible cases may exist, e.g., no ACKs are received by the transmitter, the transmitter receives ACKs from partial endpoints, or the transmitter receives ACKs from all endpoints. Then, if SLPP message retransmission is supported, how to preform retransmission in the various cases needs to be discussed.

Issue #2: what is the UE behavior when error happens during SLPP message transfer.

For example, in a legacy LPP procedure, after an endpoint performs error detection and finds that there is an error for a received LPP message, the endpoint may respond to a transmitter (or a transmitting UE) which transmits the LPP message with an error indication with an error cause. The error cause in legacy LPP procedure may include “undefined,” “lppMessageHeaderError,” “lppMessageBodyError,” “epduError,” “incorrectData Value,” “lppSegmentationError,” etc., as specified in 3GPP standard documents. However, for SLPP, there may be multiple endpoints receiving an SLPP message. If partial endpoints detect an error in a received SLPP message and respond to a transmitter (or a transmitting UE) which transmits the SLPP message with an error indication, then how the transmitter handles the error indication needs to be discussed.

Issue #3: how to determine a cast type for an SLPP message.

For example, in legacy NR SL, a cast type may be determined in a vehicle to everything (V2X) layer, and may be determined based on an SL service type. For example, some types of SL services are always broadcast, and some types of SL services are always groupcast. However, in SL positioning, a cast type used for an SLPP message may be not only determined based on a location service, but also related to other information. Then, how to determine a cast type for an SLPP message needs to be discussed.

Embodiments of the present application propose methods for SL positioning, which provide various technical solutions regarding SLPP ACK, SLPP retransmission, UE behavior when error happens for SLPP message, and cast type determination for SLPP message. Embodiments of the present application may at least address the above issues. More details on embodiments of the present application will be described in the following text in combination with the appended drawings.

According to some embodiments of the present application, an SLPP session may be established among one or more target UEs and one or more anchor UEs. In other words, these UEs form a group and are associated with the same SLPP session. The SLPP session may be associated with one location request with QoS requirement(s) for a location service. The purpose of the location request is to calculate position (or ranging) for each target UE of the one or more target UEs. The following embodiments may provide several procedures in an SLPP session.

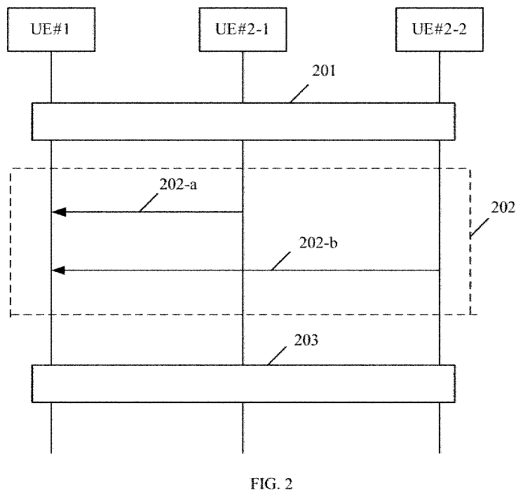

FIG. 2 illustrates an exemplary SLPP acknowledgement procedure according to some embodiments of the present application.

The method in the example of FIG. 2 may be performed by a first UE (e.g., UE #1) and multiple second UEs (e.g., UE #2-1 and UE #2-2). The first UE may refer to a transmitter (or a transmitting UE) which transmits an SLPP message. Each second UE may refer to a receiver (or a receiving UE) receives the SLPP message. In some examples, the first UE may refer to an anchor UE and each second UE may refer to a target UE. In some other examples, the first UE may refer to a target UE and each second UE may refer to an anchor UE. In some embodiments of the present application, each of the first UE and the multiple second UEs may also be referred to as an endpoint. Although two second UEs are depicted in FIG. 2 for illustrative purpose, it is contemplated that any number of second UEs may be involved in the procedure illustrated in FIG. 2. Although the method is illustrated in a system level by three UEs, persons skilled in the art can understand that the operations implemented in the first UE and those implemented in the two second UEs can be separately implemented and incorporated by other apparatus with the like functions.

Before the steps shown in FIG. 2, the first UE (e.g., UE #1) and the multiple second UEs (e.g., UE #2-1 and UE #2-2) may establish an SLPP session among them. That is, the first UE may establish an SLPP session with the multiple second UEs, or any second UE of the multiple second UEs may establish an SLPP session with the first UE and other second UE(s) in the multiple second UEs. In other words, the procedure illustrated in FIG. 2 may occur in a case that an SLPP session has been established among the first UE and the multiple second UEs. That is, the first UE and the multiple second UEs are in a group and in the established SLPP session.

In step 201, the first UE (e.g., UE #1) may groupcast an SLPP message in the SLPP session to the multiple second UEs (e.g., UE #2-1 and UE #2-2). The SLPP message may include an indicator indicating that acknowledgement for the SLPP message is requested and a sequence number of the SLPP message. For example, the indicator may be an information element (IE) such as “ackRequested” which is set to “TRUE.”

Consequently, in step 201, each second UE (e.g., UE #2-1 and UE #2-2) may receive the SLPP message groupcast from the first UE. In response to receiving the SLPP message, each second UE may decode the indicator and the sequence number included in the SLPP message. In the case that a second UE successfully decodes the indicator and the sequence number (regardless of whether a message body of the SLPP message can be correctly decoded), the second UE may transmit an SLPP acknowledgement including the sequence number of the SLPP message to the first UE, in step 202. For example, the SLPP acknowledgment may include an IE such as “ackIndicator” which is set to the sequence number of the SLPP message.

In the example of FIG. 2, it is assumed that both UE #2-1 and UE #2-2 successfully decode the indicator and the sequence number included in the SLPP message received from UE #1. Then, in step 202-a, UE #2-1 may transmit an SLPP acknowledgement including the sequence number of the SLPP message to UE #1; in step 202-b, UE #2-2 may transmit an SLPP acknowledgement including the sequence number of the SLPP message to UE #1.

In response to receiving an SLPP acknowledgement including the sequence number of the SLPP message from each of one or more second UEs (referred to as a particular set of second UEs) of the multiple second UEs, in step 203, the first UE may groupcast a next SLPP message in the SLPP session to the multiple second UEs.

In some embodiments of the present application, the particular set of second UEs may include all the multiple second UEs. For example, as shown in FIG. 2, the multiple second UEs to which UE #1 transmits the SLPP message consist of UE #2-1 and UE 190 2-2, and UE #1 may groupcast a next SLPP message in the SLPP session to UE #2-1 and UE #2-2 in response to receiving an SLPP acknowledgement including the sequence number of the SLPP message from each of UE #2-1 and UE #2-2.

In some embodiments of the present application, the particular set of second UEs may include all second UEs in the multiple second UEs which are within a minimum communication range of a groupcast service. That is, if a second UE in the multiple second UEs is out of the minimum communication range of the groupcast service, which may be indicated from a lower layer (e.g., physical layer or medium access control (MAC) layer), the SLPP acknowledgement from such UE is not counted by the first UE. For example, as shown in FIG. 2, the multiple second UEs to which UE #1 transmits the SLPP message consist of UE #2-1 and UE #2-2. In the case that UE #2-2 is out of a minimum communication range of a groupcast service, the particular set of second UEs consists of UE #2-1. Then, UE #1 may groupcast a next SLPP message in the SLPP session to UE #2-1 and UE #2-2 in response to receiving an SLPP acknowledgement including the sequence number of the SLPP message from UE #2-1, regardless of whether UE #1 receives an SLPP acknowledgement from UE #2-2.

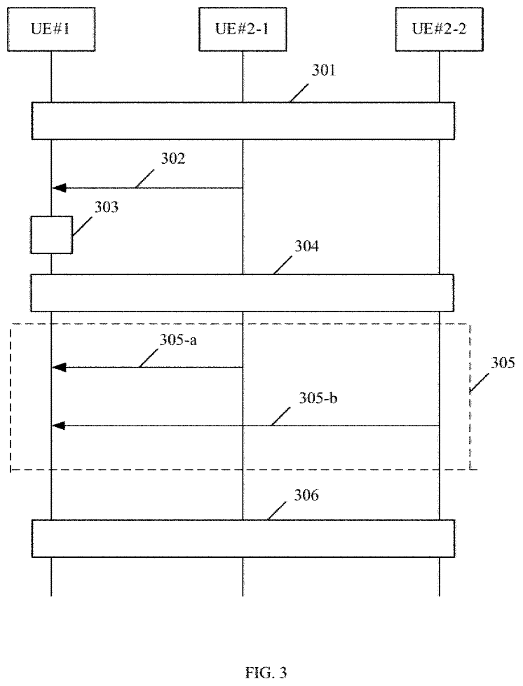

FIG. 3 illustrates an exemplary SLPP retransmission procedure according to some embodiments of the present application.

The method in the example of FIG. 3 may be performed by a first UE (e.g., UE #1) and multiple second UEs (e.g., UE #2-1 and UE #2-2). The first UE may refer to a transmitter (or a transmitting UE) which transmits an SLPP message. Each second UE may refer to a receiver (or a receiving UE) receives the SLPP message. In some examples, the first UE may refer to an anchor UE and each second UE may refer to a target UE. In some other examples, the first UE may refer to a target UE and each second UE may refer to an anchor UE. In some embodiments of the present application, each of the first UE and the one or more second UE may also be referred to as an endpoint. Although two second UEs are depicted in FIG. 3 for illustrative purpose, it is contemplated that any number of second UEs may be involved in the procedure illustrated in FIG. 3. Although the method is illustrated in a system level by three UEs, persons skilled in the art can understand that the operations implemented in the first UE and those implemented in the two second UEs can be separately implemented and incorporated by other apparatus with the like functions.

Before the steps shown in FIG. 3, the first UE (e.g., UE #1) and the multiple second UEs (e.g., UE #2-1 and UE #2-2) may establish an SLPP session among them. That is, the first UE may establish an SLPP session with the multiple second UEs, or any second UE of the multiple second UEs may establish an SLPP session with the first UE and other second UE(s) in the multiple second UEs. In other words, the procedure illustrated in FIG. 3 may occur in a case that an SLPP session has been established among the first UE and the multiple second UEs. That is, the first UE and the multiple second UEs are in a group and in the established SLPP session.

In step 301, the first UE (e.g., UE #1) may groupcast an SLPP message in the SLPP session to the multiple second UEs (e.g., UE #2-1 and UE #2-2). The SLPP message may include an indicator indicating that acknowledgement for the SLPP message is requested and a sequence number of the SLPP message. For example, the indicator may be an information element (IE) such as “ackRequested” which is set to “TRUE.”

Consequently, in step 301, each second UE (e.g., UE #2-1 and UE #2-2) may receive the SLPP message groupcast from the first UE. In response to receiving the SLPP message, each second UE may decode the indicator and the sequence number included in the SLPP message. In the case that a second UE successfully decodes the indicator and the sequence number (regardless of whether a message body of the SLPP message can be correctly decoded), the second UE may transmit an SLPP acknowledgement including the sequence number of the SLPP message to the first UE, in step 302. For example, the SLPP acknowledgment may include an IE such as “ackIndicator” which is set to the sequence number of the SLPP message. Otherwise, if a second UE cannot successfully decode the indicator and the sequence number (e.g., the second UE fails to decode at least one of the indicator or the sequence number), the second UE may not transmit an SLPP acknowledgement to the first UE.

In the example of FIG. 3, it is assumed that UE #2-1 successfully decode the indicator and the sequence number included in the SLPP message received from UE #1, while UE #2-2 does not successfully decode the indicator and the sequence number included in the SLPP message received from UE #1. Then, in step 302, UE #2-1 may transmit an SLPP acknowledgement to UE #1. UE #2-2 may not transmit an SLPP acknowledgement to UE #1.

In step 303, the first UE may determine whether no SLPP acknowledgement including the sequence number of the SLPP message has been received from at least one second UE of one or more second UEs (referred to as a particular set of second UEs) before a time period has elapsed since a last transmission (e.g., a transmission or a re-transmission) of the SLPP message. That is, the first UE may determine whether SLPP acknowledgement(s) from all second UE(s) in the particular set of second UEs has been received before the time period has elapsed since the last transmission of the SLPP message. The particular set of second UEs may have the same definitions as that provided in the embodiments described with respect to FIG. 2. For example, the particular set of second UEs may include all the multiple second UEs or include all second UEs in the multiple second UEs which are within a minimum communication range of a groupcast service.

In step 304, in response to determining that no SLPP acknowledgement including the sequence number of the SLPP message has been received from at least one second UE of the particular set of second UEs before the time period has elapsed since the last transmission of the SLPP message, the first UE may re-transmit the SLPP message to the multiple second UEs. The re-transmitted SLPP message may also include the indicator indicating that acknowledgement for the SLPP message is requested and the sequence number of the SLPP message.

In the example of FIG. 3, it is assumed that the particular set of second UEs consists of UE #2-1 and UE #2-2. Since only an SLPP acknowledgement including the sequence number of the SLPP message from UE #2-1 is received in step 302, in step 304, UE #1 may re-transmit the SLPP message to UE #2-1 and UE #2-2.

After receiving the re-transmitted SLPP message, each second UE may decode the indicator and the sequence number included in the re-transmitted SLPP message. In the case that a second UE successfully decodes the indicator and the sequence number (regardless of whether a message body of the re-transmitted SLPP message can be correctly decoded and whether the message is considered to be duplicate or not), in step 305, the second UE may transmit an SLPP acknowledgement including the sequence number of the SLPP message to the first UE. Otherwise, if a second UE cannot successfully decode the indicator and the sequence number, the second UE may not transmit an SLPP acknowledgement to the first UE.

In the example of FIG. 3, both UE #2-1 and UE #2-2 successfully decode the indicator and the sequence number included in the re-transmitted SLPP message. Then, in step 305-a, UE #2-1 may transmit an SLPP acknowledgement including the sequence number of the SLPP message to UE #1. In step 305-b, UE #2-2 may transmit an SLPP acknowledgement including the sequence number of the SLPP message to UE #1. In some other cases, if a second UE (e.g., UE #2-1) has correctly received the same SLPP message from UE #1 or has transmitted an SLPP acknowledgement for the same SLPP message to UE #1 before, the second UE may not transmit the SLPP acknowledgement for the re-transmitted SLPP message to UE #1.

The first UE may repeatedly perform step 303 and step 304 until an SLPP acknowledgement including the sequence number of the SLPP message is received from each of the particular set of second UEs or a maximum number of re-transmissions of the SLPP message is reached.

In the case that an SLPP acknowledgement including the sequence number of the SLPP message is received from each of the particular set of second UEs, the first UE may groupcast a next SLPP message in the SLPP session to the multiple second UEs in step 306. In the example of FIG. 3, since an SLPP acknowledgement including the sequence number of the SLPP message is received from both UE #2-1 and UE #2-2, UE #1 may groupcast a next SLPP message in the SLPP session to UE #2-1 and UE #2-2 in step 306.

In the case that a maximum number of re-transmissions of the SLPP message is reached, the first UE may perform one of the following operations in step 306:
The first UE may abort the SLPP session and groupcast an indication indicating that the SLPP session is aborted to the multiple second UEs (e.g., UE #2-1 and UE #2-2). For example, aborting the SLPP session may include aborting all procedures and activities associated with the SLPP session. In response to receiving the indication, each second UE (e.g., UE #2-1 and UE #2-2) may discard stored SLPP message(s) for the SLPP session and stop an ongoing SLPP transaction of the SLPP session.
The first UE may abandon a second UE (e.g., stop or abort SLPP session or SLPP transaction with the second UE) in the particular set of second UEs from which no SLPP acknowledgement including the sequence number of the SLPP message has been received (e.g., the second UE fails to decode at least one of the indicator or the sequence number), and continue the SLPP session with other second UE(s).
The first UE may re-transmit the SLPP message to a second UE in the particular set of second UEs from which no SLPP acknowledgement including the sequence number of the SLPP message has been received (e.g., the second UE fails to decode at least one of the indicator or the sequence number), via an existing unicast connection between the first UE and the second UE.
If there is no existing unicast connection between the first UE and a second UE in the particular set of second UEs from which no SLPP acknowledgement including the sequence number of the SLPP message has been received (e.g., the second UE fails to decode at least one of the indicator or the sequence number), the first UE may trigger to establish a unicast connection with the second UE and re-transmit the SLPP message to the second UE via the unicast connection.

In the example of FIG. 3, if the particular set of second UEs only include all second UEs in the multiple second UEs which are within a minimum communication range of a groupcast service, then, for a second UE which is out of the minimum communication range of the groupcast service, the SLPP acknowledgement from the second UE is not counted by the first UE for determining the retransmission of the SLPP message, and the first UE does not need to handle such second UE if no SLPP acknowledgement is received from the second UE after all re-transmissions.

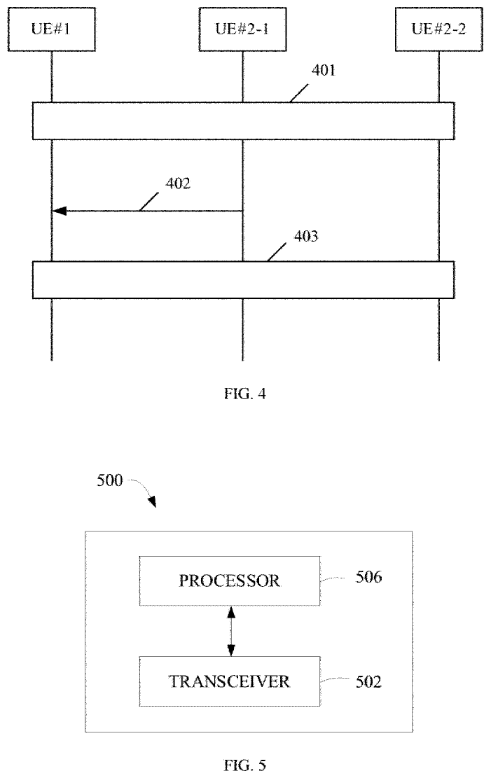

FIG. 4 illustrates an exemplary SLPP error handling procedure according to some embodiments of the present application.

The method in the example of FIG. 4 may be performed by a first UE (e.g., UE #1) and multiple second UEs (e.g., UE #2-1 and UE #2-2). The first UE may refer to a transmitter (or a transmitting UE) which transmits an SLPP message. Each second UE may refer to a receiver (or a receiving UE) receives the SLPP message. In some examples, the first UE may refer to an anchor UE and each second UE may refer to a target UE. In some other examples, the first UE may refer to a target UE and each second UE may refer to an anchor UE. In some embodiments of the present application, each of the first UE and the one or more second UE may also be referred to as an endpoint. Although two second UEs are depicted in FIG. 4 for illustrative purpose, it is contemplated that any number of second UEs may be involved in the procedure illustrated in FIG. 4. Although the method is illustrated in a system level by three UEs, persons skilled in the art can understand that the operations implemented in the first UE and those implemented in the two second UEs can be separately implemented and incorporated by other apparatus with the like functions.

Before the steps shown in FIG. 4, the first UE (e.g., UE #1) and the multiple second UEs (e.g., UE #2-1 and UE #2-2) may establish an SLPP session among them. That is, the first UE may establish an SLPP session with the multiple second UEs, or any second UE of the multiple second UEs may establish an SLPP session with the first UE and other second UE(s) in the multiple second UEs. In other words, the procedures illustrated in FIG. 4 may occur in a case that an SLPP session has been established among the first UE and the multiple second UEs. That is, the first UE and the multiple second UEs are in a group and in the established SLPP session.

In step 401, the first UE (e.g., UE #1) may groupcast an SLPP message in the SLPP session to the multiple second UEs (e.g., UE #2-1 and UE #2-2). The SLPP message may include a sequence number of the SLPP message.

Consequently, in step 401, each second UE (e.g., UE #2-1 and UE #2-2) may receive the SLPP message groupcast from the first UE. In response to receiving the SLPP message, each second UE may decode the SLPP message. In the case that a second UE detects an error for the SLPP message, in step 402, the second UE may transmit an indication indicating an error for the SLPP message to the first UE. The error may include at least one of: decoding error, segmentation error, parameter value error, etc. In the example of FIG. 4, UE #2-1 may detect an error for the SLPP message and transmit an indication indicating the error for the SLPP message to UE #1 in step 402.

Consequently, in step 402, the first UE may receive at least one indication indicating an error for the SLPP message from at least one second UE of the multiple UEs. For simplicity, FIG. 4 illustrates only one indication received by the first UE as an example.

In response to receiving an indication indicating an error for the SLPP message from a second UE (e.g., the indication from UE #2-1), the first UE may perform one of the following operations in step 403.
The first UE may abort the SLPP session and groupcast an indication indicating that the SLPP session is aborted to the multiple second UEs (e.g., UE #2-1 and UE #2-2). For example, aborting the SLPP session may include aborting all procedures and activities associated with the SLPP session. In response to receiving the indication, each second UE (e.g., UE #2-1 and UE #2-2) may discard stored SLPP message(s) for the SLPP session and stop an ongoing SLPP transaction of the SLPP session.
The first UE may determine that an SLPP transaction associated with the SLPP message is failed and groupcast an ID of the failed SLPP transaction to the multiple second UEs (e.g., UE #2-1 and UE #2-2). In response to receiving the ID of the failed SLPP transaction groupcast from the first UE, each second UE (e.g., UE #2-1 and UE #2-2) may discard stored SLPP message(s) for the failed SLPP transaction. In some cases, the first UE may re-generate SLPP message(s) for the failed SLPP transaction and groupcast the re-generated SLPP message(s) to the multiple second UEs.
The first UE may abandon (e.g., stop or abort SLPP session or SLPP transaction with) the second UE (e.g., UE #2-1), which indicates the error for the SLPP message, and continue the SLPP session with other second UEs (e.g., UE #2-2) of the multiple second UEs.

According to some embodiments of the present application, a transmitting UE which transmits an SLPP message may determine a cast type (groupcast, broadcast, or unicast) used for the SLPP message. Then, the transmitting UE may transmit the SLPP message according to the determined cast type. For example, before performing step 201 in FIG. 2, step 301 in FIG. 3, or step 401 in FIG. 4, UE #1 may determine that the cast type used for the SLPP message is groupcast, and then groupcast the SLPP message. In some examples, the cast type used for the SLPP message may be determined by an SLPP layer. In some examples, the SLPP layer may indicate the cast type used for the SLPP message to an upper layer.

In some embodiments, the transmitting UE may determine that a cast type used for an SLPP message in an SLPP session is groupcast based on at least one of:
a type of the SLPP message: for example, the transmitting UE may determine that the cast type of the SLPP message is groupcast when the SLPP message is associated with a capability transfer procedure, an assistance data transfer procedure, or an location information transfer procedure, etc;
a group layer-2 ID for a positioning group associated with the SLPP session (or associated with a location service which is associated with the SLPP session) being maintained by the transmitting UE;
a broadcast layer-2 ID associated with a location service which is associated with the SLPP session being maintained by the transmitting UE;
a number of UEs to which the SLPP message is to be transmitted being larger than 1;
no unicast connection existing between the transmitting UE and UE(s) to which the SLPP message is to be transmitted; or
a type of the transmitting UE: for example, the transmitting UE may determine that the cast type of the SLPP message is groupcast when the transmitting UE is an RSU.

FIG. 5 illustrates a simplified block diagram of an exemplary apparatus 500 for SL positioning according to some embodiments of the present application. In some embodiments, the apparatus 500 may be or include at least part of a UE (e.g., a transmitting UE or a receiving UE as described above).

Referring to FIG. 5, the apparatus 500 may include at least one transceiver 502 and at least one processor 506. The at least one transceiver 502 is coupled to the at least one processor 506.

Although in this figure, elements such as the transceiver 502 and the processor 506 are illustrated in the singular, the plural is contemplated unless a limitation to the singular is explicitly stated. In some embodiments of the present application, the transceiver 502 may be divided into two devices, such as receiving circuitry (or a receiver) and transmitting circuitry (or a transmitter). In some embodiments of the present application, the apparatus 500 may further include an input device, a memory, and/or other components. The transceiver 502 and the processor 506 may be configured to perform any of the methods described herein (e.g., the methods described with respect to FIGS. 2-4 or other methods described in the embodiments of the present application).

According to some embodiments of the present application, the apparatus 500 may be a transmitting UE (e.g., an anchor UE or a target UE), and the transceiver 502 and the processor 506 may be configured to perform operations of a transmitting UE in any of the methods as described with respect to FIGS. 2-4 or other methods described in the embodiments of the present application. For example, the processor 506 is configured to: establish an SLPP session session with multiple receiving UEs; and groupcast, with the transceiver 502, an SLPP message in the SLPP session to the multiple receiving UEs.

According to some embodiments of the present application, the apparatus 500 may be a receiving UE (e.g., an anchor UE or a target UE), and the transceiver 502 and the processor 506 may be configured to perform operations of a receiving UE in any of the methods as described with respect to FIGS. 2-4 or other methods described in the embodiments of the present application. For example, the processor 506 is configured to: establish an SLPP session with a transmitting UE and one or more other receiving UEs; and receive, with the transceiver 502, an SLPP message in the SLPP session groupcast from the transmitting UE.

In some embodiments of the present application, the apparatus 500 may further include at least one non-transitory computer-readable medium. In some embodiments of the present disclosure, the non-transitory computer-readable medium may have stored thereon computer-executable instructions to cause the processor 506 to implement any of the methods as described above. For example, the computer-executable instructions, when executed, may cause the processor 506 to interact with the transceiver 502, so as to perform operations of the methods, e.g., as described with respect to FIGS. 2-4 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL positioning, including a processor and a memory. Computer programmable instructions for implementing a method for SL positioning are stored in the memory, and the processor is configured to perform the computer programmable instructions to implement the method for SL positioning. The method for SL positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A first user equipment (UE) for wireless communication, comprising:
at least on memory; and
at least one processor coupled with the at least one memory and configured to cause the first UE to:
establish a sidelink (SL) positioning protocol (SLPP) session with multiple second UEs; and
groupcast, an SLPP message in the SLPP session to the multiple second UEs.

2. The first UE of claim 1, wherein the SLPP message includes an indication that acknowledgement for the SLPP message is requested and a sequence number of the SLPP message.

3. The first UE of claim 2, wherein the at least one processor is further configured to cause the first UE to, in response to receiving an SLPP acknowledgement including the sequence number of the SLPP message from each of one or more second UEs of the multiple second UEs, groupcast, a next SLPP message in the SLPP session to the multiple second UEs that are within a minimum communication range of a groupcast service.

4. The first UE of claim 3, wherein the at least one processor is further configured to cause the first UE to:
determine that no SLPP acknowledgement including the sequence number of the SLPP message has been received from at least one second UE of the one or more second UEs before a time period has elapsed since a last transmission of the SLPP message; and
re-transmit, the SLPP message to the multiple second UEs.

5. The first UE of claim 4, wherein the at least one processor is further configured to cause the first UE to repeatedly determine that no SLPP acknowledgement including the sequence number of the SLPP message has been received and re-transmit the SLPP message to the multiple second UEs until the SLPP acknowledgement including the sequence number of the SLPP message is received from each of the one or more second UEs or a maximum number of re-transmissions of the SLPP message is reached.

6. The first UE of claim 5, wherein, in response to the maximum number of re-transmissions of the SLPP message is reached, the at least one processor is further configured to cause the first UE to:
abort the SLPP session and groupcast, an indication that the SLPP session is aborted to the multiple second UEs;
abandon a second UE in the one or more second UEs from which no SLPP acknowledgement including the sequence number of the SLPP message has been received;
re-transmit the SLPP message to the second UE, from which no SLPP acknowledgement including the sequence number of the SLPP message has been received, via an existing unicast connection; or
establish a unicast connection with the second UE, from which no SLPP acknowledgement including the sequence number of the SLPP message has been received, for re-transmitting the SLPP message to the second UE.

7. The first UE of claim 1, wherein the at least one processor is further configured to cause the first UE to:
receive, an indication of an error for the SLPP message from a second UE of the multiple second UEs; and
in response to receiving the indication:
abort the SLPP session and groupcast, an indication that the SLPP session is aborted to the multiple second UEs;
determine that an SLPP transaction associated with the SLPP message is failed and groupcast, an identity (ID) of the failed SLPP transaction to the multiple second UEs; or
abandon the second UE and continue the SLPP session for other second UEs of the multiple second UEs.

8. The first UE of claim 1, wherein the at least one processor is further configured to cause the first UE to determine that a cast type used for the SLPP message is groupcast based on at least one of:
a type of the SLPP message;
a group layer-2 ID for a positioning group associated with the SLPP session being maintained by the first UE;
a broadcast layer-2 ID associated with a location service which is associated with the SLPP session being maintained by the first UE;
more than one of the multiple second UEs to which the SLPP message is to be transmitted;
no unicast connection existing between the first UE and one or more of the multiple second UEs to which the SLPP message is to be transmitted; or
a type of the first UE.

9. A second user equipment (UE) for wireless communication, comprising:
at least on memory; and
at least one processor coupled with the at least one memory and configured to cause the second UE to:
establish a sidelink (SL) positioning protocol (SLPP) session with a first UE and one or more other second UEs; and
receive, an SLPP message in an SLPP session groupcast from the first UE.

10. The second UE of claim 9, wherein the SLPP message includes an indicator that acknowledgement for the SLPP message is requested and a sequence number of the SLPP message.

11. The second UE of claim 10, wherein the at least one processor is further configured to cause the second UE to transmit, an SLPP acknowledgement including the sequence number of the SLPP message in response to receiving the SLPP message and successfully decoding the indicator and the sequence number.

12. The second UE of claim 10, wherein, if the second UE fails to decode at least one of the indicator or the sequence number, the at least one processor is further configured to cause the second UE to:
receive the SLPP message re-transmitted from the first UE via an existing unicast connection; or
establish a unicast connection with the first UE, and receive the SLPP message re-transmitted from the first UE via the unicast connection.

13. The second UE of claim 9, wherein the at least one processor is further configured to cause the second UE to, in response to detecting an error for the SLPP message, transmit, an indication of an error for the SLPP message to the first UE.

14. The second UE of claim 9, wherein the at least one processor is further configured to cause the second UE to:
in response to receiving an indication that the SLPP session is an aborted groupcast from the first UE, discard one or more stored SLPP messages for the SLPP session and stop an ongoing SLPP transaction of the SLPP session; or
in response to receiving an identity (ID) of a failed SLPP transaction groupcast from the first UE, discard one or more stored SLPP messages for the failed SLPP transaction.

15. A method performed by a first user equipment (UE), the method comprising:
establishing a sidelink (SL) positioning protocol (SLPP) session with multiple second UEs; and
groupcasting an SLPP message in the SLPP session to the multiple second UEs.

16. The method of claim 15, wherein the SLPP message includes an indication that acknowledgement for the SLPP message is requested and a sequence number of the SLPP message.

17. The method of claim 16, further comprising:
in response to receiving an SLPP acknowledgement including the sequence number of the SLPP message from each of one or more second UEs of the multiple second UEs, groupcasting a next SLPP message in the SLPP session to the multiple second UEs that are within a minimum communication range of a groupcast service.

18. The method of claim 17, further comprising:
determining that no SLPP acknowledgement including the sequence number of the SLPP message has been received from at least one second UE of the one or more second UEs before a time period has elapsed since a last transmission of the SLPP message; and
re-transmitting the SLPP message to the multiple second UEs.

19. The method of claim 18, further comprising:
repeatedly determining that no SLPP acknowledgement including the sequence number of the SLPP message has been received; and
re-transmitting the SLPP message to the multiple second UEs until the SLPP acknowledgement including the sequence number of the SLPP message is received from each of the one or more second UEs or a maximum number of re-transmissions of the SLPP message is reached.

20. A method performed by a second user equipment (UE), the method comprising:
establishing a sidelink (SL) positioning protocol (SLPP) session with a first UE and one or more other second UEs; and
receiving an SLPP message in an SLPP session groupcast from the first UE.
